(19) United States
(12) Patent Application Publication
(10) Pub. No.: US 2008/0257814 A1
(43) Pub. Date: Oct. 23, 2008

(54) Filtration Cartridge

(75) Inventors: James J. Vigna, Billerica, MA (US); Paul Lowell, Wilmington, MA (US); Joseph M. Almasian, Westford, MA (US)

Correspondence Address: MILLIPORE CORPORATION, 290 CONCORD ROAD, BILLERICA, MA, 01821, US

(73) Assignee: Millipore Corporation, Billercia, MA (US)

(21) Appl. No.: 12/080,352

(22) Filed: Apr. 1, 2008

Related U.S. Application Data
(60) Provisional application No. 60/925,774, filed on Apr. 23, 2007.

(51) Int. Cl. B01D 63/08

(52) U.S. Cl. 210/321.84

(57) ABSTRACT

A filtration cartridge is provided comprising one or a stack of filtration units sealed to each other at their inner periphery and their outer periphery and to end caps thereby eliminating the need for a housing surrounding the stack. Fluid pathways are provided so that filtration of all incoming feed is assured prior to passing from the cartridge as filtrate.

### CROSS-REFERENCE RELATED APPLICATIONS

This application claims the benefit of U.S. Provisional Patent Application No. 60/925,774, filed on Apr. 23, 2007, the entire contents of which are incorporated by reference herein.

### BACKGROUND OF THE INVENTION

This invention relates to a filtration cartridge and more particularly to a filtration cartridge free of a separate exterior housing.

Membrane filters of various polymeric materials are known and are generally thin porous structures having porosities between about 50-80% by volume. They are relatively fragile and are commonly used with various types of mechanical support or reinforcement. Flow rates of liquids through such membranes per unit of area are a function of pore size. To obtain high flow rates through filters with fine pores, for example below about one micron, relatively large filter areas are needed. Such areas have therefore been provided by using large individual filters or by using a number of smaller individual filters in parallel. For use in critical pharmaceutical applications such as sterilization, such membranes and their supporting apparatus must be free of leaks or defects capable of passing small particles or organisms.

Numbers of small filters have theretofore been hand-assembled for parallel flow with supporting plates and associated apparatus, then tested, and, if necessary, sterilized, often at the user's site at considerable cost and inconvenience. The operations must be repeated if the hand assembly fails the necessary tests. The mechanical parts of larger more complex filtration systems are generally cleaned and re-used, only the filters being replaced. One assembly heretofore provided in disposable plastic has also been mechanically secured with relatively moveable parts.

Individual membrane filters of large area have been supported flat or cylindrically, or have been pleated for disposition in compact housings. Holders for flat membranes are large, for a given filter area, are usually not disposable, and also require disassembly, cleaning, reassembly and testing with each change of filter. Pleating of fragile membranes creates stress concentrations at the folds, permits flexing of the fragile membranes in use, normally requires interleaving flow screens on one or both of the upstream and downstream sides and requires potting and/or adhesives to seal the ends and overlapping seams. Because of concerns for possible failures at the folds, seams, or ends, a separate flat final filter is sometimes used in series with pleated cartridges for added assurance in critical applications, for example, in sterilizing pharmaceuticals and intravenous fluids. In addition, the use of a number of different materials in pleated cartridge construction increases the sources for extractibles into the filtrate.

U.S. Pat. No. 4,501,663 discloses a filtration cartridge formed from a plurality of stacked filtration modules and having a separate exterior housing. The cartridge is undesirable since it has a large hold up volume which results in sample loss.

Accordingly, it would be desirable to provide a filtration cartridge having a large filtration area and a low hold up volume. Such a cartridge would provide large capacity filtration with minimum sample loss.

### SUMMARY OF THE INVENTION

The present invention provides a filtration cartridge formed from one or a plurality of filtration units which are stacked and bonded to each other to assure fluid flow from an inlet to the filtration cartridge, through at least one membrane and through an outlet from the filtration cartridge. The filtration mode is dead ended, normal flow filtration (NFF). Each filtration unit comprises one membrane support plate or two membrane support plates sealed together at their inner and outer peripheries. Each membrane support plate has a first surface and a second surface. A filtration membrane, such as a single membrane or a composite membrane having one or more membrane layers is bonded to each of the first and second surfaces of each membrane support plate. The filtration cartridge is provided with end caps, one having an inlet and one having an outlet. Each end cap is sealed to an isolation plate which prevents fluid from entering the interior of the end cap. A fluid deflection plate is sealed to the top isolation plate and functions to direct incoming fluid to the outer radial portion of the filtration units.

### BRIEF DESCRIPTION OF THE DRAWINGS

FIG. 1 is a perspective view of the filtration cartridge of this invention.

FIG. 2a is a perspective view of the bottom surface of a fluid deflection plate used in the filtration cartridge of this invention.

FIG. 2b is a perspective view of the top surface of the fluid deflection plate of FIG. 2a.

FIG. 3a is a bottom view of a second surface of a membrane support plate utilized in the filtration cartridge of this invention.

FIG. 3b is a top view of a first surface of the membrane support plate of FIG. 3a.

FIG. 3c is a cross-sectional view at the outlet of the membrane support plate of FIGS. 3a and 3b.

FIG. 4 is a cross sectional view of a filtration cartridge of this invention having two filtration units.

FIG. 5a is a perspective view of the outer surface of an end cap of the filtration cartridge of this invention.

FIG. 5b is a perspective view of the inner surface of the end cap of FIG. 5a.

FIG. 6a is a perspective view of the bottom surface of an isolation plate having a vent of the filtration cartridge of this invention.

FIG. 6b is a perspective view of the top surface of the isolation plate of FIG. 6a.

FIG. 7 is an exploded cross sectional view of an alternative filtration cartridge of this invention utilizing one membrane support plate.

FIG. 8 is an exploded cross sectional view of an alternative filtration cartridge of this invention utilizing one membrane support plate.

FIG. 9a is a perspective view of the bottom surface of the bottom isolation plate utilized in the cartridge of FIG. 7.

FIG. 9b is a perspective view of the top surface of the isolation plate of FIG. 9a.

FIG. 10a is a perspective view of the bottom surface of the fluid deflection plate used in the cartridge of FIG. 8.

FIG. 10b is a perspective view of the top surface of the fluid deflection plate of FIG. 10a.

### DESCRIPTION OF SPECIFIC EMBODIMENTS

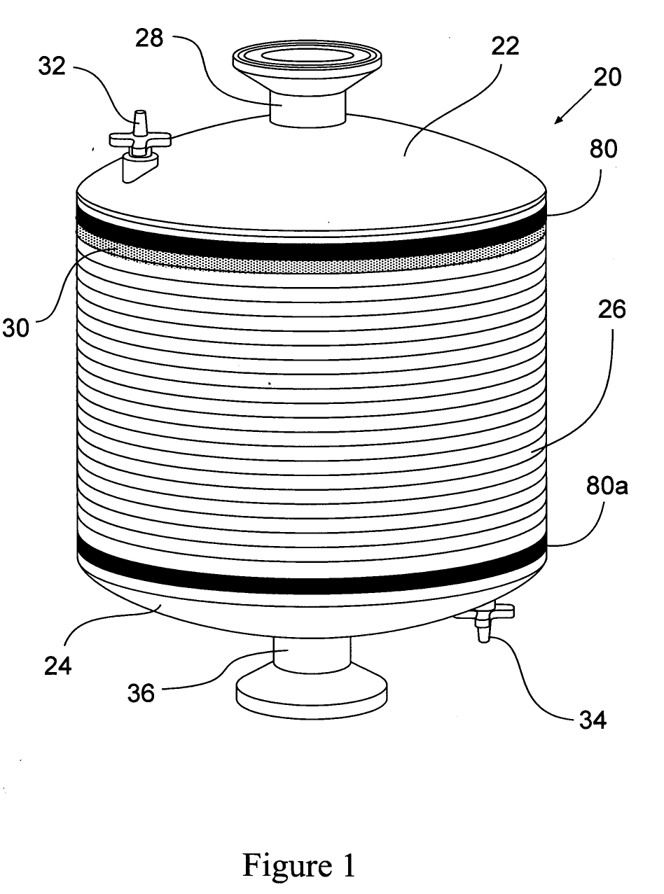

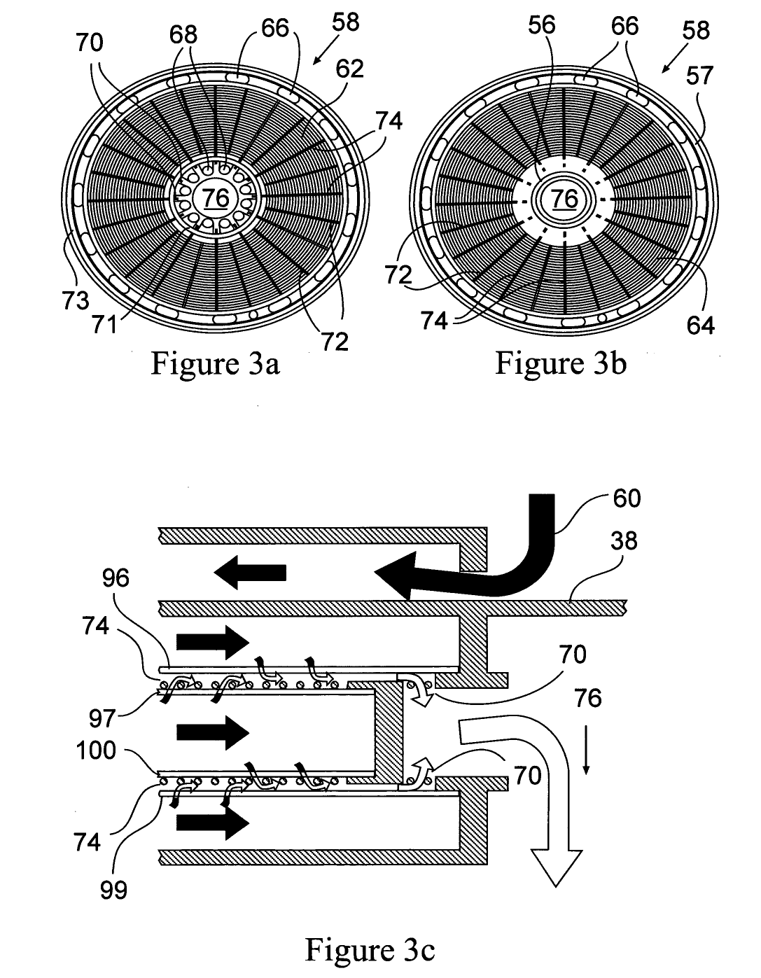

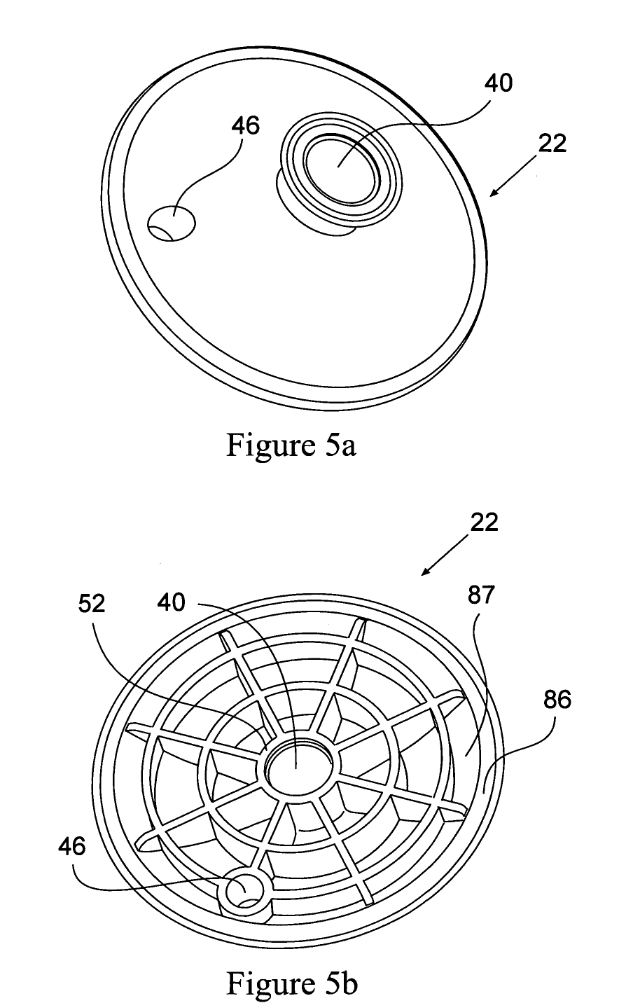

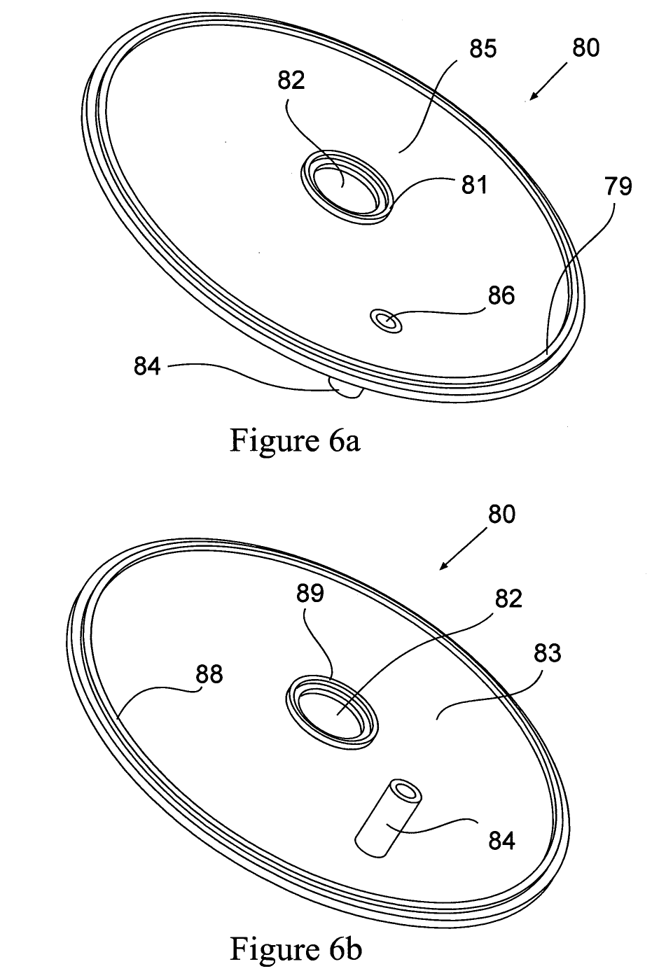

Referring to FIG. 1, a self contained filtration cartridge 20 having, for example, 0.5 square meters of filter area, is shown. The cartridge 20 comprises an upper end cap 22, a lower end cap 24, a deflection plate 30, isolation plates 80 and 80a and a plurality of filtration units 26 between the deflection plate 30 and the isolation plate 80a. Lower end cap 24 has the same configuration as top end cap 22 (FIGS. 5a and 5b). Isolation plate 80a has the same configuration as isolation plate 80 (FIGS. 6a and 6b). Filtration units 26 are made by bonding two membrane support plates 58 (FIGS. 3a, 3b). Preferably the end caps 22 and 24 and the filtration units 26 are of the same plastic material and are selectively welded together such as with heat or solvent at their inner and outer peripheries. End caps 22 and 24 are provided with fittings 28, 36 respectively adapted for connection to an outlet conduit of tubing or the like which is attached to the fittings 28, 36. Fitting 28 comprises an inlet to the stack of filtration units 26, from the outlet of a conduit attached to it such as by clamping (not shown). Fitting 36 comprises an outlet from the stack of filtration units 26 to the inlet of a conduit attached to it such as by clamping (not shown).

A vent 32 of any suitable type is attached to the isolation plate 80 and extends through the end cap 22 to permit the venting of air from the filtration cartridge at start-up. This may comprise, for example, a manually opening valve which is opened to exhaust air and thereafter closed. End cap 24 is provided with a vent 34 similar in structure and function as vent 32 and an outlet 36. Vent 34 is attached to isolation plate 80a and extends through end cap 24.

In use, a liquid to be filtered enters inlet fitting 28, passes into the stack of filtration units 26, passes through the filtration membranes within the stack of filtration units 26, as hereinafter described, from which the filtrate passes out outlet fitting 36.

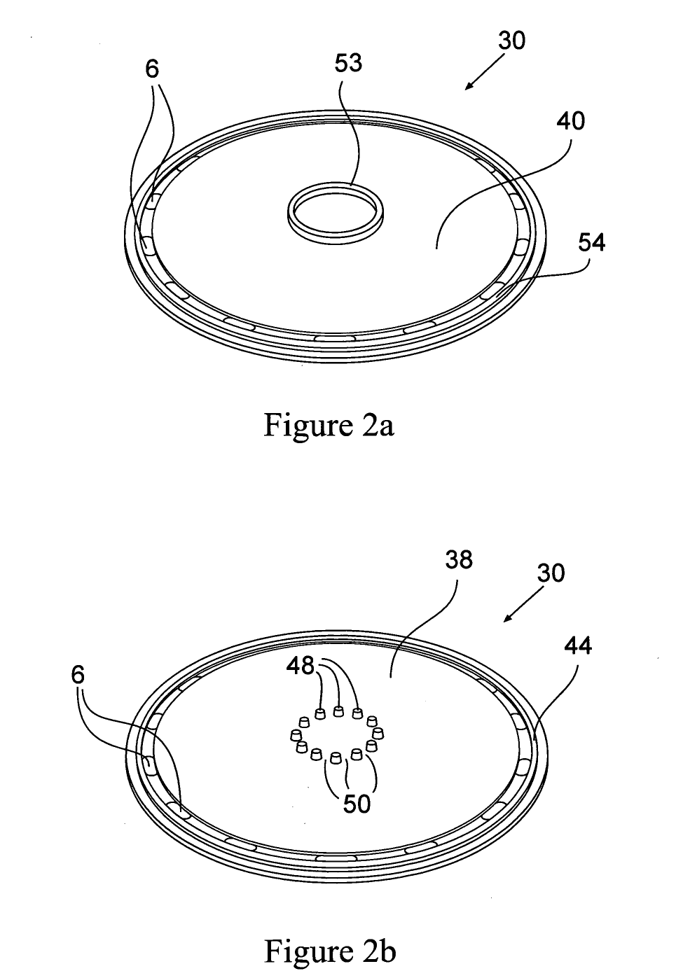

Referring to FIGS. 2a and 2b, a fluid deflection plate 30 is shown having a top surface 38 and a bottom surface 40. Top surface 38 of plate 30 is bonded such as by thermal welding to an inner surface 85 on isolation disk 80 having a fluid inlet 82 (FIGS. 6a and 6b). The prongs 48 are bonded to inner periphery surface 81 (FIG. 6a). The outer periphery surface 44 is bonded to outer periphery surface 79 (FIG. 6a). Top surface 38 of plate 30 has, at a central location coincident with a fluid inlet 28, (FIG. 1) a plurality of the prongs 48 which provide spaces 50 to effect fluid flow therebetween. The bottom surface 40 includes a flat inner peripheral surface 53 which is bonded such as by thermal bonding to flat inner peripheral surface 56 of membrane support plate 58 (FIG. 3b). The outer peripheral surface 54 is bonded to outer peripheral surface 57 (FIG. 3b). The fluid deflection plate 30 includes peripheral fluid pathways (holes) 6 which permit fluid flow from spaces 50 to surfaces of filtration membranes as described below.

Referring to FIGS. 3a, 3b, and 3c, a membrane support plate 58 has a top surface 64 (FIG. 3b) and a bottom surface 62 (FIG. 3a). The membrane support plate 58 is provided with peripheral fluid pathways (holes) 66 to effect fluid flow through filtration membranes as described below. The holes 66 and holes 6 (FIGS. 2a and 2b) can be aligned or nonaligned so long as fluid flow is effected therethrough. The bottom surface 62 is provided with prongs 68 having spaces 70 therebetween to permit fluid through the spaces 70. The bottom surface 62 is bonded to a second membrane support plate having the same design as bottom surface 62 in a stack of filtration units 26 as described below. The top surface 64 is bonded such as by thermal bonding to a second membrane support plate having the same design as the top surface 64. To form a filtration unit from two membrane support plates, the prongs 68 are bonded to prongs of the same configuration on the second membrane support plate. Bottom surface 62 has a plurality of fluid flow paths 72 which alternate with a plurality of fluid flow paths 74 on top surface 64. The flow paths 72 and 74 on surfaces 62 and 64 are covered with filtration membranes. Each filtration membrane can comprise one or more membrane layers such as composite membranes. Incoming fluid 60 contacts the top surface 38 of defection plate 30 (FIG. 2b) and is directed radially outward to holes 6 (FIG. 2b). Prongs 68 surround fluid outlet 76 for passage of filtrate therethrough as described below.

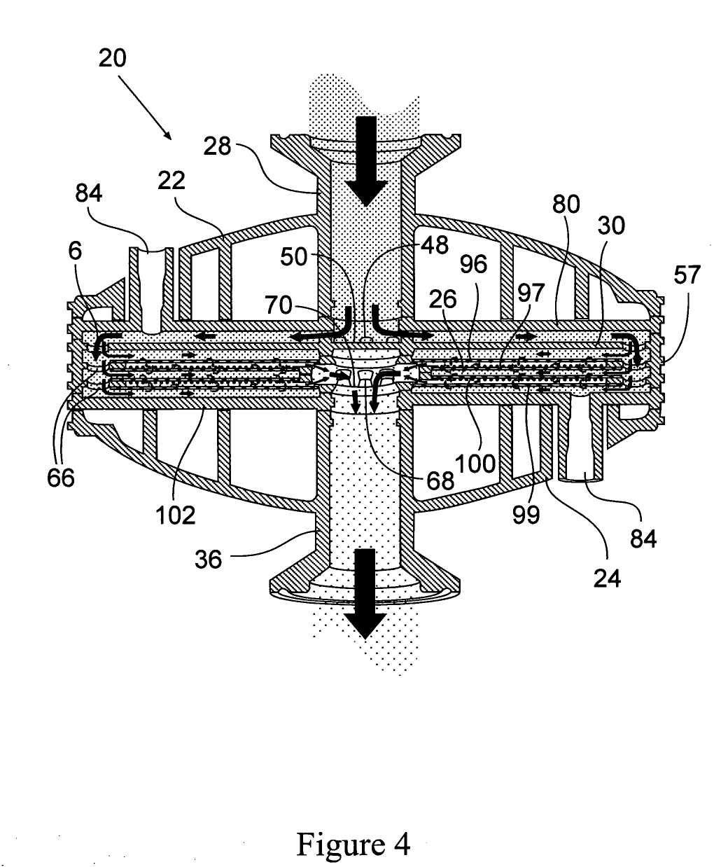

Referring to FIG. 4, the filtration cartridge 20 comprises a top end cap 22, an isolation plate 80, a deflection plate 30, a filtration unit 26, an isolation plate 102 and a bottom end cap 24.

Referring to FIG. 4 in use, incoming feed fluid to be filtered enters inlet fitting 28 to contact fluid deflection plate 30. The fluid passes between prongs 48 through passageways 50, and travels radially outward and then through holes 6 (FIG. 2b) and holes 66 (FIG. 3a). The feed fluid passes over and then through membranes 96, 97, 99 and 100, through the spaces 70 between prongs 68 (FIG. 3a) and out the outlet fitting 36 to be collected as filtrate.

Referring to FIGS. 5a and 5b, the end cap 22 (as well as end cap 24) is provided with an inlet 40 and a hole 46 through which fitting 84 (FIG. 6b) extends. Inner peripheral surface 52 and outer peripheral surface 86 are bonded respectively to surfaces 89 and 88 respectively of isolation disk 80 (FIG. 6b).

Referring to FIGS. 6a and 6b, isolation disk 80 has a top surface 83 (FIG. 6b) and a bottom surface 85 (FIG. 6a). Disk 80 is provided with a fluid flow path 82 which can function as either a fluid inlet or a fluid outlet as described below. The disk 80 is provided with a fitting 84. The fitting 84 comprises a housing for a vent 32 or 34 (FIG. 1) to permit passage of gas or liquid from the cartridge 20 interior during start up. The top surface 83 is bonded, such as by thermal bonding to the bottom surface 87 of end cap 22 at its outer peripheral flat surface 88 to outer peripheral surface 86 (FIG. 5b) and its inner peripheral surface 89 is bonded to inner peripheral surface 52 of end cap 22 (FIG. 5b).

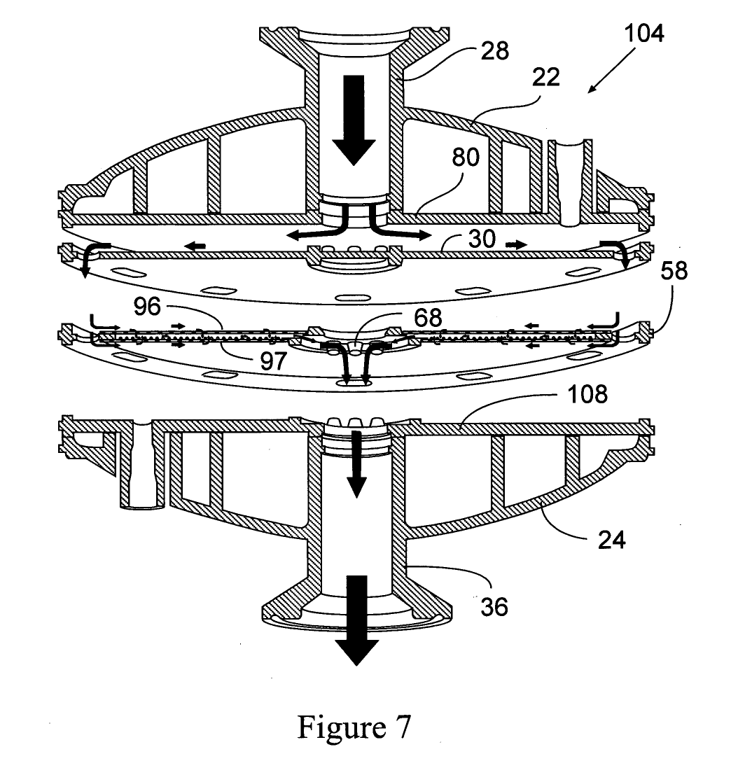

Referring to FIG. 7, the filter cartridge 104 comprises a top end cap 22 bonded to top isolation plate 80. Top isolation plate 80 is bonded to fluid deflection plate 30 at their respective outer and inner adjacent surfaces. Deflection plate 30 is bonded to membrane support plate 58 at their respective outer and inner adjacent peripheral surfaces. Plate 58 has bonded thereto filtration membranes 96 and 97. Membrane support plate 58 is bonded to bottom isolation plate 108 at their respective outer and inner adjacent peripheral surfaces. Bottom isolation plate 108 is bonded to bottom end cap 24. Isolation plate 80 prevents hold up fluid from entering top end cap 22. Isolation plate 108 prevents hold up liquid from entering bottom end cap 24.

Referring to FIG. 7 in use, incoming feed fluid to be filtered enters inlet fitting 28 to contact fluid deflection plate 30. The fluid passes between prongs 48 through passageways 50, and travels radially outward and then through holes 6 (FIG. 2b). The feed fluid passes over and then through membranes 96 and 97, through the spaces 70 between prongs 68 (FIG. 3a) and out the outlet fitting 36 to be collected as filtrate.

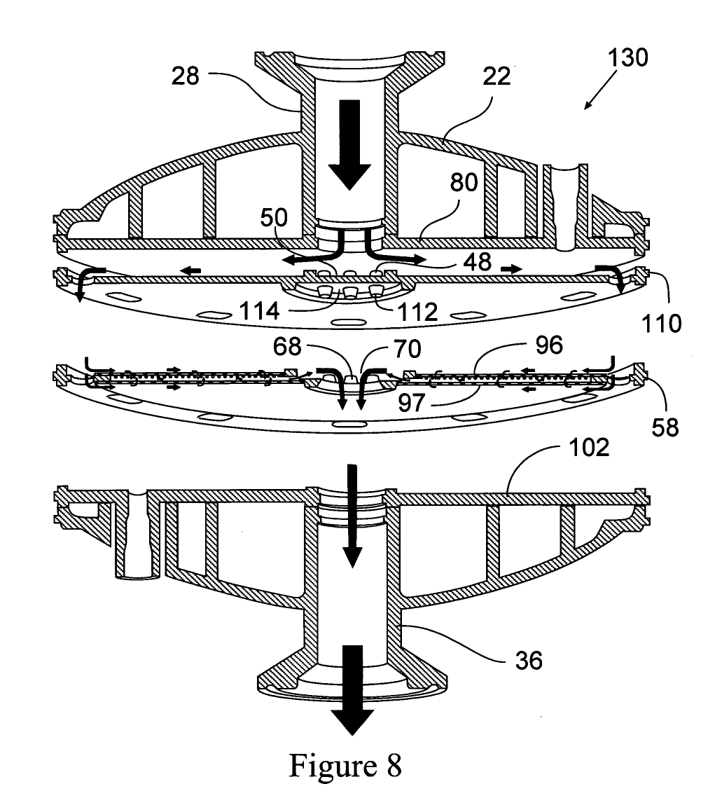

Referring to FIG. 8, the filter cartridge 130 comprises a top end cap 22 bonded to top isolation plate 80. Top isolation plate 80 is bonded to fluid deflection plate 110 at their respective outer and inner adjacent surfaces. Deflection plate 110 is bonded to membrane support plate 58 at their respective outer and inner adjacent peripheral surfaces. Plate 58 has bonded thereto filtration membranes 96 and 97. Membrane support plate 58 is bonded to bottom isolation plate 102 at their respective outer and inner adjacent peripheral surfaces. Bottom isolation plate 102 has the same configuration as top isolation plate 80. Bottom isolation plate 102 is bonded to bottom end cap 24. Isolation plate 80 prevents hold up fluid from entering top end cap 22. Isolation plate 102 prevents hold up liquid from entering bottom end cap 24. Referring to FIG. 8, incoming feed fluid to be filtered enters inlet fitting 28 to contact fluid deflection plate 110. The fluid passes between prongs 48 through passageways 50 and travels radially outward through holes 111. The feed fluid passes over and through membranes 96 and 97, through spaces 70 between prongs 68 (FIG. 3a) and out the outlet fitting to be collected as filtrate.

By sealing the stack of elements as described above to their outer peripheral surfaces and inner peripheral surfaces, the need for an outer housing to prevent leakage is eliminated.

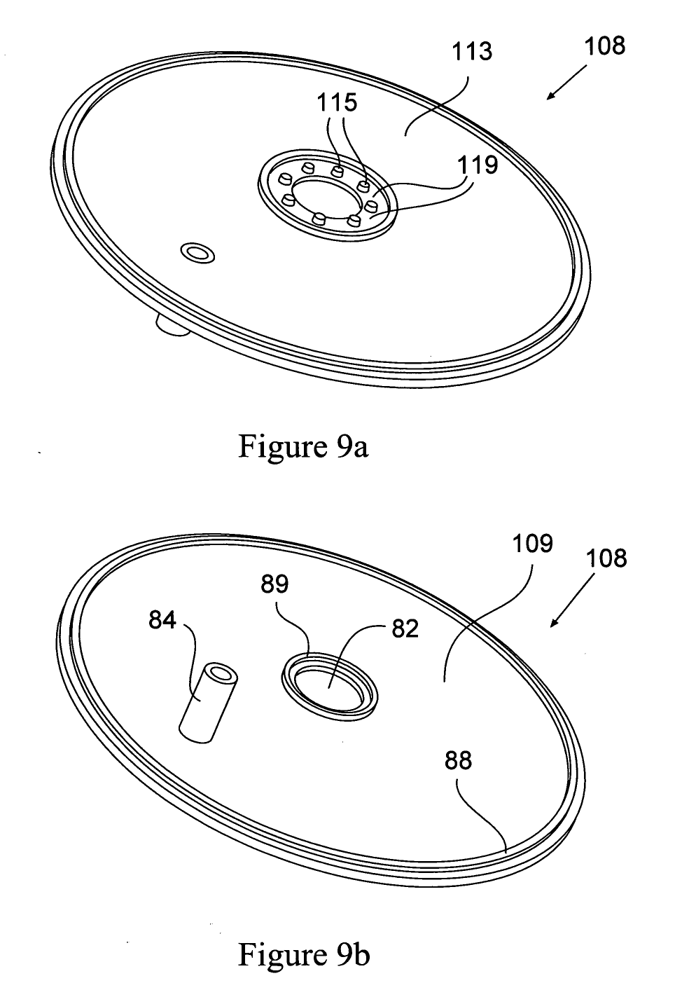

Referring to FIGS. 9a and 9b, isolation disk 108 has a top surface 109 and a bottom surface 113. Disk 108 is provided with a fluid flow path 82 which can function as either a fluid inlet or a fluid outlet as described above. The disk 108 is provided with a fitting 84. The fitting 84 comprises housing for a vent 32 to permit passage of gas or liquid from the cartridge 104 interior during start up. The top surface 109 is bonded, such as by thermal bonding to the bottom surface of end cap 24 at its outer peripheral flat surface 88 to outer peripheral surface 86 (FIG. 5b) and its inner peripheral flat surface 89 is bonded to inner peripheral surface 52 of end cap 24 (FIG. 5b). Cap 24 has the same configuration as cap 22. Disk 108 is provided with prongs 115 having spaces 119 therebetween. Prongs 115 are bonded to prongs 68 of disc 58 (FIG. 3a) to provide fluid passageways that communicate with outlet 36.

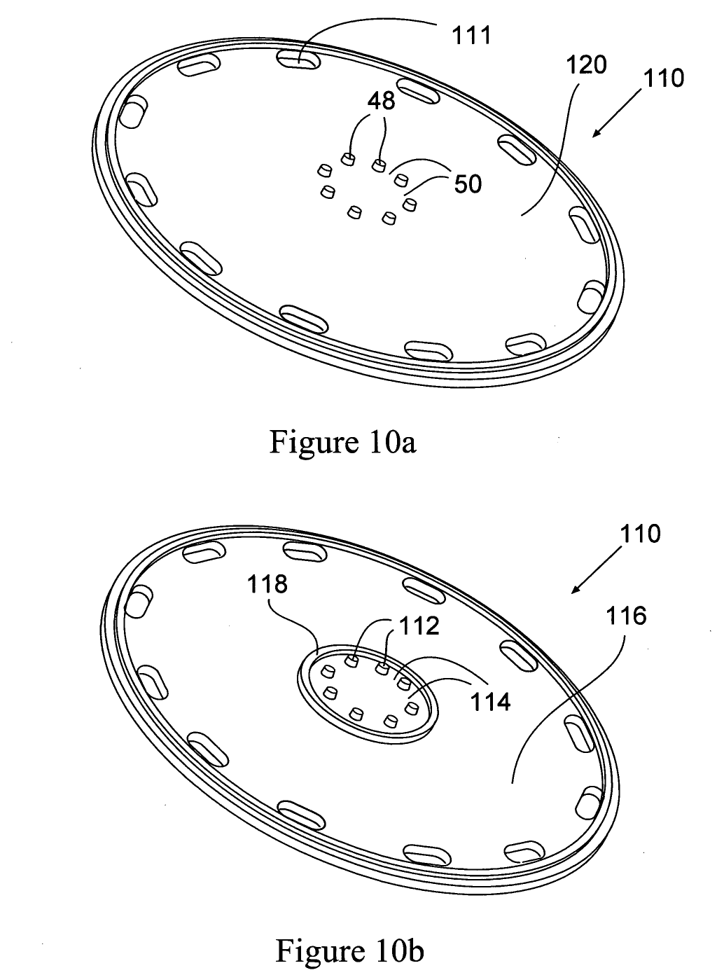

Referring to FIGS. 10a and 10b, fluid deflection plate 110 (See FIG. 8) includes a set of bottom prongs 112 having spaces 114 therebetween on bottom surface 116. An inner periphery surface 118 is sealed to inner peripheral surface 71 of membrane support plate 58 (FIG. 3a). The top surface 120 has top prongs 48 having spaces therebetween and function in the same manner as described above (FIG. 2b). The plate 110 has holes 111.

The above invention may be used for size exclusion filtration, in which the particles of a size greater than that of the pores of the membrane are prevented from flowing through the membrane.

Alternatively, it may be used with other types of filtering membranes. One such type of membrane is an adsorber membrane which contains a chemistry such as an ion exchange chemistry (anionic or cationic chemistries) or hydrophobic interaction chemistries or affinity chemistries such as Protein A or G ligands, which bind selected constituents, generally contaminants such as host cell proteins (HCP), nucleic acids, endotoxins, viruses, etc. and remove them from the fluid stream. Alternatively, the chemistry can bind the desired molecule (peptide or protein, antibody and the like) and allow the remainder of the fluid and its components to flow through. The membrane(s) are then washed to remove any residual unbound material and then the desired molecule is eluted from the membrane by a change in the liquid (pH, ionic strength, etc.).

What is claimed:

1. A filtration cartridge having a fluid inlet and a fluid outlet comprising,
at least one filtration unit, each unit comprising at least one membrane support plate, each of the membrane support plates having a filtration membrane bonded to a bottom surface of the membrane support plate and to a top surface of the membrane support plate,
the membrane support plates being bonded to each other at an inner peripheral surface and at an outer peripheral surface to form seals to prevent fluid feed from entering the fluid outlet except by having passed through at least one of the membranes,
a top end cap having the fluid inlet,
a bottom end cap having the fluid outlet,
a first isolation plate bonded to the top end cap,
a second isolation plate bonded to the bottom end cap and to one of the filtration units,
a deflection plate bonded to one of the filtration units and to the first isolation plate,
and fluid flow paths from the fluid inlet, through the membranes and through the fluid outlet that prevent fluid feed from the inlet from bypassing the membranes.

2. The filtration cartridge of claim 1 which include prongs having spaces therebetween within the fluid flow paths.

3. The filtration cartridge of claim 1 wherein the deflection plate includes prongs having spaces therebetween.

4. The filtration cartridge of claim 1 wherein the cartridge has a plurality of the filtration units.

5. The filtration cartridge of claim 1 wherein the cartridge has a plurality of the filtration units and the deflection plate includes prongs having spaces therebetween.

6. The filtration cartridge of claim 1 wherein the membrane support plates include fluid pathways which permit filtrate flow from the top surface and from the bottom surface of each of the membrane support plates to the fluid outlet.

7. The filtration plate of claim 1 wherein each of the end caps includes an open vent.

8. A filtration cartridge having a fluid inlet and a fluid outlet comprising,
a filtration unit, comprising a membrane support plate, the membrane support plate having a filtration membrane bonded to a bottom surface of the membrane support plate and to a top surface of the membrane support plate,
the membrane support plate being bonded to a first isolation plate and a deflection plate at an inner peripheral surface and at an outer peripheral surface of the membrane support plate to form seals to prevent fluid feed from entering the fluid outlet except by having passed through at least one of the membranes,
a top end cap having the fluid inlet,
a bottom end cap having the fluid outlet,
a second isolation plate bonded to the top end cap,
the first isolation plate bonded to the bottom end cap and to the filtration unit,
the deflection plate bonded to the filtration unit and to the second isolation plate,
and fluid flow paths from the fluid inlet, through the membranes and through the fluid outlet that prevent fluid feed from the inlet from bypassing the membranes.

9. The filtration cartridge of claim 8 wherein the cartridge includes prongs having spaces therebetween within the fluid flow paths.

10. The filtration cartridge of claim 8 wherein the deflection plate includes prongs having spaces therebetween.

11. The filtration cartridge of claim 8 wherein the membrane support plates include fluid pathways which permit filtrate flow from the top surface and from the bottom surface of each of the membrane support plates to the fluid outlet.

12. The filtration plate of claim 8 wherein each of the end caps includes an open vent.
